(19) United States
(12) Patent Application Publication
(10) Pub. No.: US 2018/0125745 A1
(43) Pub. Date: May 10, 2018

(54) SELF MYOFASCIAL RELEASE TOOL

(71) Applicant: Matthew Olaya, Huntington Beach, CA (US)

(72) Inventor: Matthew Olaya, Huntington Beach, CA (US)

(21) Appl. No.: 15/654,531

(22) Filed: Jul. 19, 2017

Related U.S. Application Data
(63) Continuation of application No. 14/030,173, filed on Sep. 18, 2013, now abandoned.
(60) Provisional application No. 61/354,658, filed on Jun. 14, 2010.

(51) Int. Cl. A61H 15/00

(52) U.S. Cl. CPC A61H 15/00; A61H 2201/1695; A61H 2015/0014; A61H 2201/0111

(57) ABSTRACT

A therapeutic roller includes an elongate, cylindrical body having an elastomer surface forming a tread pattern, a thermoplastic core interior to the surface, and an adhesive layer affixing the surface to the core.

### RELATED APPLICATIONS

This application is a continuation of U.S. patent application Ser. No. 14/030,173 filed Sep. 18, 2013, which is based on U.S. Provisional Application No. 61/354,658, filed on Apr. 29, 2013, the contents and disclosure of both of which are incorporated herein by reference.

### BACKGROUND OF THE INVENTION

Self-myofascial release is a type of soft tissue therapy utilizing tissue manipulation to achieve muscle relaxation via stretching and autogenic inhibition.

Self-myofascial rollers are often utilized in self-myofascial release therapy. The self-myofascial are rolled across each muscle group (e.g. gastrocnemius, latissimus dorsi, piriformis, adductors, quadriceps, hamstrings, hip flexors, trapezius, rhomboids, and the tensor fasciae latae muscles), the user maintaining pressure from the self-myofascial roller on selected areas for selected periods of time.

Self-myofascial rollers may be constructed of foam and/or hard plastics. Foam rollers tend to lose their shape with extended use, in turn decreasing the foam roller's ability to provide the requisite pressure for self-myofascial release. On the other hand, hard plastic rollers provide a consistently firm surface that can in turn be uncomfortable for the user. Self-myofascial rollers have been proposed that combine hard plastic cores with foam outer shells. These combination rollers alleviate some of the discomfort, but the foam outer shell eventually still loses its shape and effectiveness with extended use.

It is therefore desirable to provide therapeutic rollers that are comfortable, durable and effective.

### SUMMARY OF THE INVENTION

A therapeutic roller according to the embodiment of the present invention is described herein that overcomes the limitations noted above.

The primary objective is to provide a therapeutic roller is comprised of an elongate, cylindrical body having an elastomer surface forming a tread pattern, a thermoplastic core interior to the surface, and an adhesive layer affixing the surface to the core.

Another objective of this invention IS to provide therapeutic rollers that are comfortable, durable and effective.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention. In such drawing(s):

FIG. 1 illustrates a therapeutic roller according to an embodiment of the present invention; and

FIG. 2 illustrates a preferred tread pattern on a therapeutic roller according to an embodiment of the present invention.

### DETAILED DESCRIPTION OF THE PREFERRED EMBODIMENTS

The above described drawing figures illustrate the described invention in at least one of its preferred, best mode embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. Therefore, it should be understood that what is illustrated is set forth only for the purposes of example and should not be taken as a limitation on the scope of the present apparatus and its method of use.

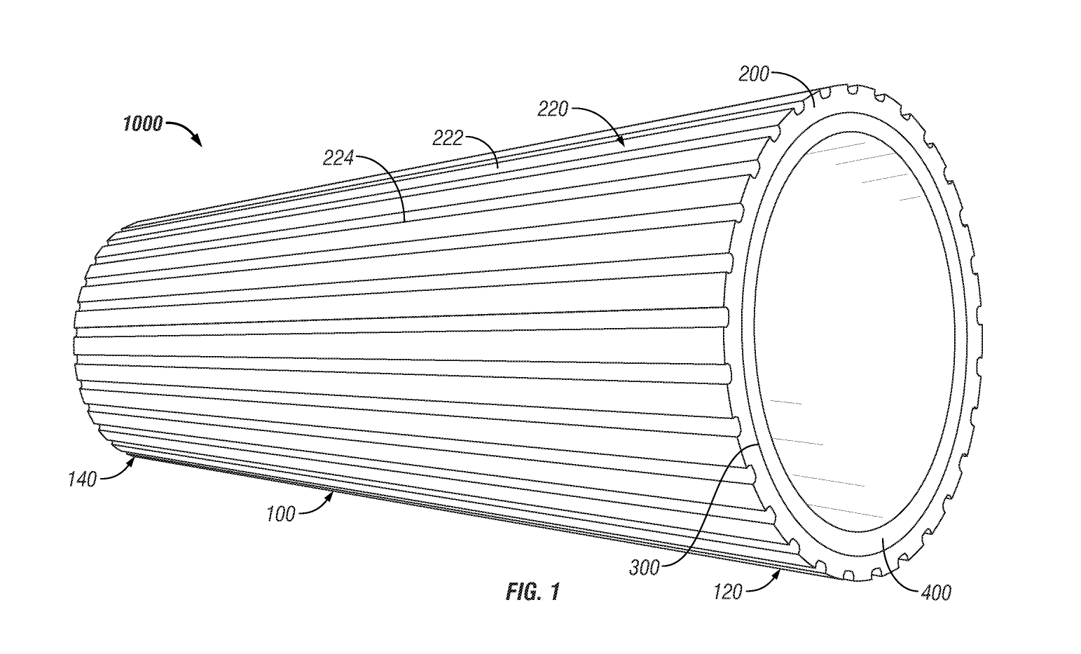

FIG. 1 illustrates a therapeutic roller 1000 according to at least one preferred embodiment of the present invention.

The therapeutic roller comprises an elongate cylindrical body 100 having a surface 200, a core 400 interior to the surface, and opposing distal ends 120 and 140. The body has a length that is preferably between 15 and 30 inches. Preferably, the body has a length of 15 inches. The body has a diameter that is preferably between 0.5 and 5 inches. Preferably, the body has a diameter of 4.75 inches.

As shown in FIG. 1, the surface may be constructed of a polymer material, preferably an elastomer so as to provide flexible resistance to a user during self-myofascial release or other similar therapy. Preferably, the surface is constructed of ethylene vinyl acetate (EVA) or the like.

In at least one embodiment, the surface has a thickness that is preferably between 0.125 and 0.25 inches, the thickness selected so as to provide flexible resistance to a user during self-myofascial release or other similar therapy. Preferably, the surface has a thickness of approximately 0.25 inches.

In at least one embodiment, the surface is substantially water-resistant so as to inhibit the accumulation of bacteria on and/or within the surface.

As shown in FIG. 1, the core is preferably a hollow tube extending substantially the entire length of the body and being open at its distal ends. However, it is specifically contemplated that the core comprises any combination of one or more tubes that are open and/or closed at the distal ends. Moreover, the core may be a solid core, or may be a semi-solid core.

In at least one embodiment, the core has a thickness that is preferably between 0.125 and 0.25 inches, the thickness selected so as to provide support for the surface and resistance to the user during self-myofascial release or other similar therapy. Preferably, the core has a thickness of approximately 0.25 inches.

The core may be constructed of a polymer material, preferably a thermoplastic. The core may be substantially more rigid than the surface, and therefore may provide support for the surface. Preferably, the core is constructed of acrylonitrile butadiene styrene (ABS).

As shown in FIG. 1, the surface may be affixed to the exterior of the core via an adhesive layer 300 interposed between the surface and the core. The adhesive layer may consist of a liquid adhesive, a double sided adhesive tape, a pressure sensitive adhesive, or any other adhesive operable to securely adhere the surface to the core. Preferably, the adhesive is a 300 LSE adhesive manufactured by 3M™.

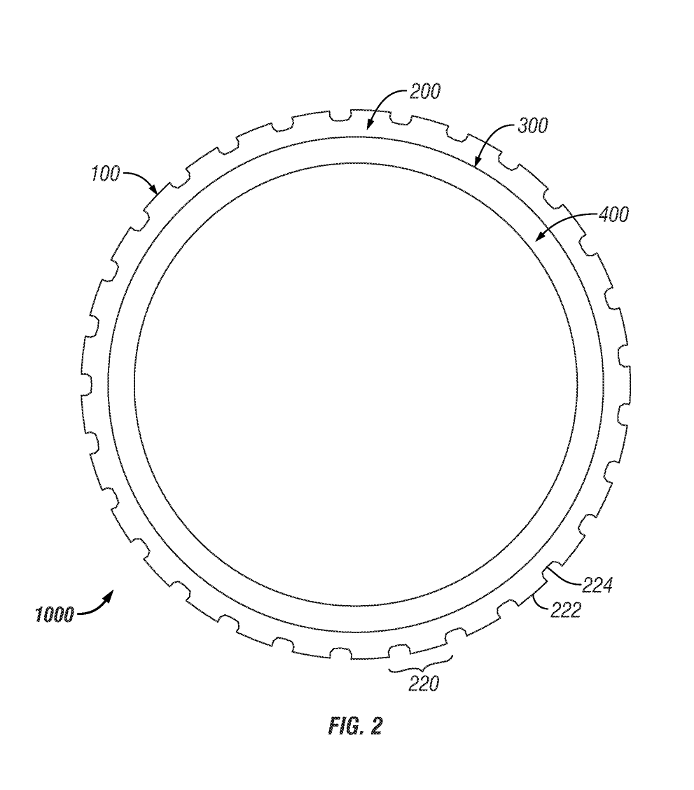

FIG. 2 illustrates an exemplary surface having a tread pattern 220 according to at least one preferred embodiment. The tread pattern comprises a series of elevations 222 and depressions 224 that repeat about the circumference of the cylindrical body and extend the length thereof. In at least one embodiment, the tread pattern is molded from the surface so as to provide the user with increased muscle stimulation during self-myofascial release or other similar therapy.

In at least one preferred embodiment, the elevations and/or depressions have a substantially rectangular profile. The tread pattern shown in FIG. 2 illustrates an example of elevations having substantially rectangular profiles. Moreover, in at least one preferred embodiment, the elevations and/or depressions have a substantially arcuate profile. The tread pattern shown in FIG. 2 illustrates an example of depressions having substantially accurate profiles. While tread patterns with substantially rectangular and/or substantially arcuate profiles are described herein, it will be apparent to one of ordinary skill in the art that other profiles may be utilized without departing from the scope of the invention.

In at least one embodiment, the tread pattern is a homogenous, regular pattern. Each elevation may have a thickness between 0.5 and 0.75 inches, as measured from the core, and preferably has a thickness of 0.5 inches. Each depression may have a thickness between 0.375 and 0.5 inches, as measured from the core, and preferably has a thickness of 0.375 inches. Moreover, each elevation may have a width (e.g. an arc length relative a central axis of the body) between 0.3125 and 0.375 inches, and preferably has a width of 0.3125. Each depression may have a width between 0.21875 and 0.25 inches, and preferably has a width of 0.25.

The enablements described in detail above are considered novel over the prior art of record and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventor believes that the claimed subject matter is what is intended to be patented.

1. A therapeutic roller comprising:
an elongate, cylindrical body having:
an elastomer surface forming a tread pattern;
a thermoplastic core interior to the surface; and
an adhesive layer affixing the surface to the core.

2. The therapeutic roller of claim 1, wherein the surface is made of ethylene vinyl acetate.

3. The therapeutic roller of claim 1, wherein the core is made of acrylonitrile butadiene styrene.

4. The therapeutic roller of claim 1, wherein the core is hollow.

5. The therapeutic roller of claim 1, wherein the core is solid.

6. The therapeutic roller of claim 1, wherein the body has a diameter between 4.25 and 4.5 inches.

7. The therapeutic roller of claim 1, wherein the surface has a diameter between 4 and 5 inches.

8. The therapeutic roller of claim 1, wherein the core has a diameter between 3 and 4 inches.
